(19) United States
(12) Patent Application Publication
(10) Pub. No.: US 2010/0171657 A1
(43) Pub. Date: Jul. 8, 2010

(54) SYSTEM AND METHOD FOR WIRELESS POSITIONING AND LOCATION DETERMINATION

(75) Inventor: Lichuan Liu, DeKalb, IL (US)

Correspondence Address: KOHN & ASSOCIATES, PLLC, 30500 NORTHWESTERN HWY, SUITE 410, FARMINGTON HILLS, MI, 48334, US

(73) Assignee: Northern Illinois University, DeKalb, IL (US)

(21) Appl. No.: 12/483,317

(22) Filed: Jun. 12, 2009

Related U.S. Application Data
(60) Provisional application No. 61/060,897, filed on Jun. 12, 2008.

(51) Int. Cl. G01S 19/10; G01S 19/45; G01S 19/46; G01S 3/02

(52) U.S. Cl. 342/357.09; 342/357.14; 342/386; 342/463

(57) ABSTRACT

According to the present invention, there is provided a system and method for wireless sensor networks (WSN) positioning which is cost-effective, scalable, can be easily implemented, and provides excellent performance and accuracy. In the present invention, a few reference nodes with known locations transmit linear frequency modulation continuous waves (FMCW), while sensor nodes receive these waves and calculate the range difference among them based on the time frequency difference arrival (TFDA). The location information of the sensor nodes is obtained through the solving of a set of hyperbolic equations. This technique is cost-efficient, scalable and can be easily implemented.

### BACKGROUND OF THE INVENTION

1. Field Of The Invention

The invention generally relates to the field of wireless sensor networks. Specifically, the invention relates to the areas of wireless positioning and location determination.

2. Description Of Related Art

Wireless sensor networks (WSN) have gathered attention recently due to their wide applications in both military and civilian areas (e.g., environmental monitoring and protection, tragedy rescue, wild animal protection, etc.). Positioning is a key factor for these important applications. Receiving data from a node without the node's location information is not particularly useful and sometimes useless. Moreover, the availability to determine a wireless node's position information enables more efficient protocols and routing algorithms. Position-based routing has several advantages over node-based and data-based routing, such as: no need to maintain routing tables, and good resilience to mobility.

There are two general approaches to localization: (1) coarse-grained localization, using minimal information, and (2) fine-grained localization, using detailed information. In the case of coarse-grained localization, the minimal information could be binary proximity (i.e., can one node hear another?), or cardinal direction information (in a set of nodes, which one is the closest to a given node?). With such information, the broad location of a node can be obtained. Approaches in this class include: binary proximity, centroid calculation, geometric constraints, approximate point in triangle, and identifying code construction (ID-CODE) algorithm. These approaches require lower network resources and have lower cost because only minimal information is required. However, the primary drawback is that less accurate information results.

Although a Global Positioning System (GPS) can provide a receiver's absolute coordinates, this positioning service is available only when at least four satellites are visible. GPS positioning techniques cannot be well utilized in many environments, such as indoors, urban areas with tall buildings, tunnels, or forests. Even when receiver nodes are deployed in GPS friendly conditions, there are drawbacks related to power, size and cost that may make the solution undesirable. Sensor nodes can be very small, for example, wearable sensors. Thus, it may be difficult to integrate GPS receivers into sensor nodes whose power, physical size and cost are highly limited. Moreover, political considerations may affect the availability of GPS signals due to external factors. For example, the Selective Availability (SA) policy can dramatically decrease GPS' positioning accuracy.

Technically, in a GPS system, the GPS receiver needs to demodulate the received satellite signals first, and then it uses coarse-acquisition (C/A) Gold code to separate them, known as C/A decoding. The receiver also obtains the signal receiving time from its local clock. After decoding, the receiver calculates the sending time of the signal from each satellite, which takes two steps: (1) the receiver uses the C/A Gold code with the same pseudo-random number sequence as the satellite's to compute an offset that generates the best correlation. This process is repeated until a correlation peak appears or all 1023 possible cases have been tried. If all 1023 cases have been tried without valid correlation, the frequency oscillator is offset to the next value and the process is repeated, and (2) the receiver begins reading the satellite broadcasting navigation message (including almanac, ephemeris parameters, etc.). After being read and interpreted, the sending time embedded in the message can be acquired. At this time, the receiver can obtain one time of arrival (TOA) by computing hardware and software using a GPS receiver.

The most common fine-grained positioning technologies include: received signal strength (RSS), angle of arrival (AOA), TOA, and time difference of arrival (TDOA). The RSS method measures the received signal's power which may change if the environment is changing. In WSN with a time-varying channel, the measured results are not reliable. Thus, the position information obtained based on RSS is imprecise. The AOA approach relies on an antenna array for determining the angle of an arrival signal. Therefore, no such option exists for small size sensors with single antenna setting. The TOA method measures the signal arrival time, which is used by the GPS positioning calculation. Its fine synchronization is the key component that determines the positioning resolution. TDOA is widely used for cell phone positioning applications such as E911. This method also requires the time synchronization among different stations, which is available in cellular networks. However, this requirement is difficult to satisfy for sensor nodes with limited communication and computational abilities.

Therefore, there exists the need for a highly-precise position method with only limited synchronization requirements.

### SUMMARY OF THE INVENTION

The present invention provides a system and method for wireless sensor networks (WSN) positioning which is cost-effective, scalable, can be easily implemented, and provides excellent performance and accuracy. In the present invention, a few reference nodes with known locations transmit linear frequency modulation continuous waves (FMCW), while sensor nodes receive these waves and calculate the range difference among them based on the time frequency difference arrival (TFDA). The location information of the sensor nodes is obtained through the solving of a set of hyperbolic equations. This technique is cost-efficient, scalable and can be easily implemented.

### DESCRIPTION OF THE DRAWINGS

Other advantages of the present invention will be readily appreciated, as the same becomes better understood by reference to the following detailed description when considered in connection with the accompanying drawings wherein:

FIG. 1 is a diagram depicting the relationship between reference nodes (RN) and general sensor nodes (GN), according to one aspect of the present invention; and

FIG. 2 is a block diagram illustrating the TFDA method of the present invention.

### DETAILED DESCRIPTION OF THE INVENTION

In wireless sensor networks (WSN), location information acquisition is critical to ensure network performance and efficiency. The present invention provides a new WSN positioning system and method which is cost-effective, scalable, can be easily implemented, and provides excellent performance and accuracy. In the present invention, a few reference nodes with known locations transmit linear frequency modulation continuous waves (FMCW), while other sensor nodes receive these waves and calculate the range difference among them based on the time frequency difference arrival (TFDA). The location information of the sensor nodes is obtained through the solving of a set of hyperbolic equations. This technique is cost-efficient, scalable and can be easily implemented.

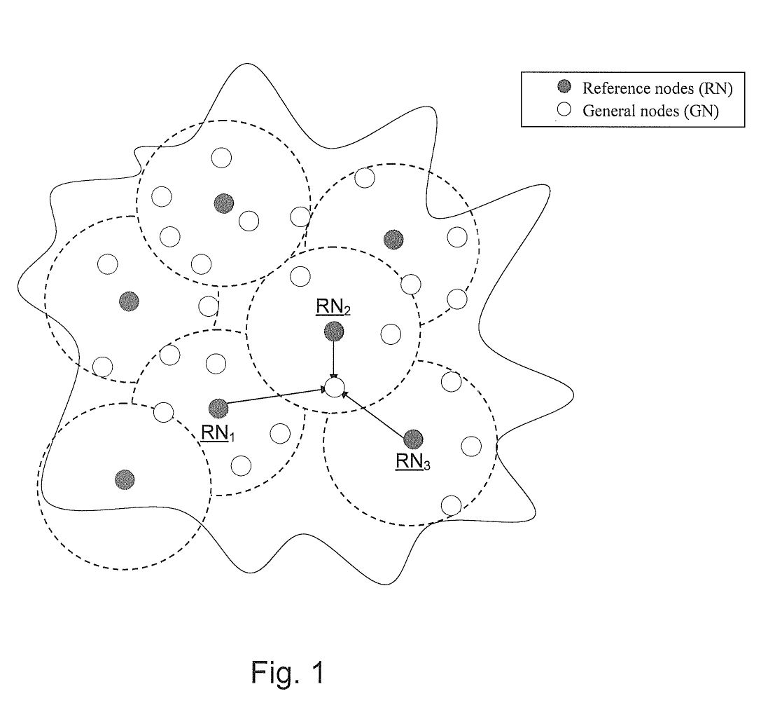

The present invention is embodied as a wireless sensor network deployed in a predetermined area. FIG. 1 depicts a small proportion of devices, known as reference nodes (RN) (1), which have a priori information regarding their coordinates. These RNs are equipped with GPS receivers (including hardware and software) or alternatively, global reference systems, such as accelerometers, compasses and gyros in order to obtain their own position information. They have transmitters which can transmit sensing data, control information and the linear FMCW signals as well. They also have receivers which can be used to receive data or information. Other nodes known as general nodes (GN) (2) do not know their positions in advance. These GNs do not need the positioning equipment, such as GPS or gyro, as they determine their own locations using the method of the present invention. They have transmitters and receivers for transmitting and receiving sensing data and control information, and they can also receive linear FMCW signals from RNs.

In the preferred embodiment the reference nodes are equipped with GPS receivers or, alternatively, global reference systems, such as accelerometers, compasses and gyros in order to obtain their own position information. These reference nodes have perfect synchronization with each other. Furthermore, in the preferred embodiment each RN has a unique identification (ID), and they are orthogonal to each other, ensuring their synchronization. The reference nodes broadcast their IDs, location information, and linear FM signals (also called chirp signals) to their neighbors simultaneously, using broadcasting tools known to those of skill in the art. The general sensor nodes (GN) in turn receive the chirp signals transmitted by the RNs. A general node can receive several chirp signals form different reference nodes at the same time.

Upon receiving these chirp signals, a GN then obtains the frequency difference between two (or more) received chirp signals by mixing the various received signals. In the preferred embodiment, this is accomplished by taking the frequency difference between the frequencies, multiplying it by the speed of light, and then dividing it by the sweeping bandwidth, as is known to those of skill in the art. Based on the information of several RN nodes' position and the range differences among them, the GN is then capable of calculating its own location accurately, as described below. In one embodiment of the present invention, the GN obtains the two range differences among three RNs, thereby determining two hyperbolic equations, as is known to those of skill in the art. The GN then solves the set of hyperbolic equations, as is known to those of skill in the art, which identifies the intersection of the two hyperbolic lines, thereby allowing the GN to estimate its own 2-dimensional location accurately.

In operation, each reference node (RN) transmits a chirp signal for a specified duration, starting at a determined time. As mentioned, a general sensor node (GN) is capable of receiving several linear FMCW signals simultaneously. The GN mixes the received signals together (as described above), and then filters them with a low-pass filter to produce a superposition of different frequencies, as is known to those of skill in the art. The GN then uses a mixer to multiply the received signals, as is known to those of skill in the art. Low pass-filtering is then performed, resulting in only the difference terms remaining. The intermediate frequency signals are derived by the GN by mixing the signals and filtering out the higher order products by a low-pass filter, as described. It should be noted that all received signals can be used to obtain time frequency difference arrival values (TFDAs) by applying the fast Fourier transform (FFT) algorithm concurrently. The GN achieves this using digital signal processing hardware or software.

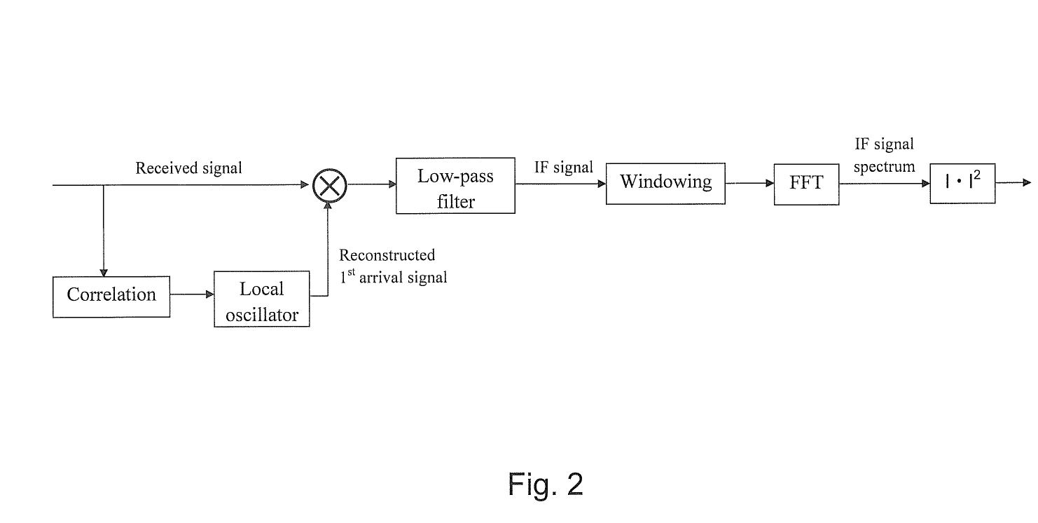

As described, in the preferred embodiment of the present invention, the time-frequency differential arrival (TFDA) method is used, as depicted in FIG. 2. As described above, the GN receives (3) linear FMCW signals from various neighboring RNs. The GN uses a local oscillator (4) to generate a local linear FMCW signal, as is known to those of skill in the art. The GN also uses a correlation method (5) to find the time shift, thereby extracting the first arrival linear FMCW signal from its nearest RN (6). This first arrival signal is then used by the GN to mix with the additional linear FMCW signals (transmitted by RNs) received by the GN. A low pass filter (7) is then used by the GN to remove the high frequency components and let the intermediate frequency (the frequency difference) pass, as described above. After this windowing process (8), the signal's power spectrum is calculated by using the fast Fourier transform (FFT) algorithm (9), as is known to those of skill in the art. In doing so, the frequency differences among the first arrival signal and others can be obtained, thereby allowing the GN to calculate their respective range differences (as described above), and thus, their locations. Due to high-speed digital signal processors and fast algorithms, calculating time frequency arrival (TFDAs) is time and cost efficient. Once a GN determines TFDAs and the locations of the RNs, the GN can calculate its own position by solving a set of hyperbolic equations (10), as described in detail above. In the preferred embodiment, the Taylor iterative method is used by the GN for solving the hyperbolic equation set, as is known to those of skill in the art.

The TFDA positioning system of the present invention includes hardware and software components such as a mixer and a low-pass filter, as well as a windowing function, FFT, and magnitude square calculating algorithms.

In the present invention, the intermediate frequency (IF) signal can be derived by mixing the signal from the various nodes and filtering out the higher order products by using a low-pass filter.

In a WSN, after deploying RN nodes carefully, each general node can obtain the superposition of several TFDAs, and it can then calculate the multiple range difference estimates. Many TFDAs can be separated by taking the Fourier Transform of the IF single, and determine the range difference through frequency. Because of the Fast Fourier Transform (FFT) algorithm and state of art Digital Signal Processing (DSP) technology this is an easy, low-cost task.

When three or more RNs can be heard by a GN, an iterative Taylor-series method is used for solving the hyperbolic equations, as is known to those of skill in the art.

It should be noted that the general nodes of the present invention can also transmit and become reference nodes once their position has been determined. Thus, the present invention's accuracy continues to improve as the positions of more general nodes are determined.

When implemented, the present invention provides increased accuracy, speed, and efficiency in determining wireless positioning over the prior art.

The invention has been described in an illustrative manner, and it is to be understood that the terminology used is intended to be in the nature of words of description rather than of limitation.

Obviously, many modifications and variations of the present invention are possible in light of the above teachings. It is, therefore, to be understood that within the scope of the appended claims, the invention may be practiced otherwise than as specifically described.

What is claimed is:

1. A wireless sensor network positioning system comprising: a plurality of reference nodes for determining relative position, a plurality of general sensor nodes whose position is to be determined, transmission means for transmitting data and communication between the nodes, detecting means for receiving transmissions, calculating means for calculating a range difference, and determining means for determining location information.

2. The positioning system of claim 1, wherein said reference nodes include precise coordinate data.

3. The positioning system of claim 1, wherein said reference nodes include GPS receivers.

4. The positioning system of claim 1, wherein said reference nodes further include global reference systems, such as accelerometers, compasses and gyros.

5. The positioning system of claim 1, wherein said reference nodes are synchronized with one another.

6. The positioning system of claim 1, wherein said reference nodes possess unique identification numbers.

7. The positioning system of claim 1, wherein said general nodes can receive a plurality of transmissions simultaneously.

8. The positioning system of claim 1, wherein said transmission means includes means for broadcasting identification, location, and linear FM signals.

9. The positioning system of claim 1, wherein said calculating means includes a computation program for determining the frequency difference amongst a plurality of signals.

10. The positioning system of claim 1, wherein said determining means includes a computation program for computing a node's location based on received node locations and computed range differences.

11. A wireless sensor network positioning method comprising the steps of:
deploying a plurality of reference nodes, deploying a plurality of general nodes, transmitting an identifying signal, detecting an identifying signal, calculating a range difference, and determining location information.

12. The positioning method of claim 11, wherein said calculating step includes determining the frequency difference amongst a plurality of signals.

13. The positioning method of claim 11, wherein said determining step includes computing a node's location based on received node locations and computed range differences.
